(19) United States
(12) Patent Application Publication
(10) Pub. No.: US 2021/0229940 A1
(43) Pub. Date: Jul. 29, 2021

(54) IMAGE FORMING APPARATUS FOR DRIVING PICKUP ROLLER

(71) Applicant: HEWLETT-PACKARD DEVELOPMENT COMPANY, L.P., Spring, TX (US)

(72) Inventors: Seungjin JUNG, Suwon-si (KR); Ji-Hoon WOO, Hwaseong-si (KR)

(73) Assignee: HEWLETT-PACKARD DEVELOPMENT COMPANY, L.P., Spring, TX (US)

(21) Appl. No.: 17/050,288

(22) PCT Filed: Nov. 29, 2018
(86) PCT No.: PCT/KR2018/015008

§ 371 Date: Oct. 23, 2020

(30) Foreign Application Priority Data
Jun. 12, 2018 (KR) 10-2018-0067409

(51) Int. Cl. B65H 3/06; G03G 15/00

(52) U.S. Cl. CPC B65H 3/0669; G03G 15/6529; G03G 15/6552

(57) ABSTRACT

An image forming apparatus is provided. The image forming apparatus according to an embodiment includes a paper-feeding device configured to accommodate paper, a print engine configured to form an image on paper supplied from the paper-feeding device, and a discharging device configured to discharge paper on which an image is formed by the print engine, wherein the paper-feeding device comprises a pick-up roller in a cylindrical shape configured to pick up paper loaded in a tray, a driving shaft configured to support the pick-up roller to idly rotate, and rotate in a predetermined direction, a solenoid configured to selectively rotate the driving shaft; and a power transmission member configured to selectively provide a driving force of the driving shaft to the pick-up roller, the power transmission member being coupled to or spaced apart from the pick-roller, wherein the power transmission member is engaged with the pick-up roller within a predetermined rotational range of the driving shaft.

### BACKGROUND ART

### Disclosure of Invention

An image forming apparatus is an apparatus for generating, printing, receiving, and transmitting image data. Representative examples include a printer, a copier, a facsimile, and a multifunction printer that integrally implements these functions.

An image forming apparatus includes a paper-feeding device which supplies paper to a printing device provided therein. Paper accommodated in the paper-feeding device may be picked up by a pick-up roller and conveyed to a print engine along a convey path.

### BRIEF DESCRIPTION OF DRAWINGS

FIG. 1 is a schematic view illustrating an image forming apparatus according to an embodiment of the present disclosure;

FIG. 2 is a perspective view illustrating a paper-feeding device according to an embodiment of the present disclosure;

FIG. 3 is a perspective view illustrating a portion of the paper-feeding device according to an embodiment of the present disclosure;

FIG. 4 is an exploded view illustrating the portion of the paper-feeding device shown in FIG. 3; and

FIGS. 5A and 5B are schematic views showing an operation state of a pick-up roller according to an embodiment of the present disclosure.

### MODE FOR THE INVENTION

Hereinafter, various embodiments of the present disclosure will be described in detail with reference to the accompanying drawings. The embodiments to be described below may also be modified in various forms. In order to more clearly describe features of the embodiments, a detailed description of matters which are well known to those to skilled in the art to which the embodiments pertain will be omitted.

Meanwhile, in the present specification, a case in which any component is “connected” with another component includes a case in which any component is ‘directly connected’ to another component and a case in which any component is ‘connected to another component while having the other component interposed therebetween’. In addition, a case in which any component “comprises” another component means that any component may further comprise other components, not exclude other components, unless explicitly described to the contrary.

The expression “image forming job” as used herein may refer to various jobs related with image, such as, formation of image or generation/storage/transmission of image files (e.g., printing, scanning or faxing), and the expression “job” as used herein may refer to not only the image forming job, but also a series of processes required for performance of the image forming job.

In addition, an “image forming device” refers to a device of printing print data generated from a terminal such as a computer on a recoding paper. Examples of the image forming device described above may include a copier, a printer, a facsimile, a multi function printer (MFP) of complexly implementing functions thereof through a single device, and the like. The image forming device may mean all devices capable of performing an image forming task, such as the printer, the scanner, the fax machine, the multi-function printer (MFP), or a display.

Further, the expression “hard copy” as used herein may refer to an operation of outputting image on a recording medium such as paper, and the expression “soft copy as used herein may refer to an operation of outputting image on a display device such as a TV, a monitor or the like.

The expression “content” as used herein may refer to any type of data as a subject of the image forming job, such as picture, image, document file or the like.

The expression “printing data” as used herein may refer to data converted into format that can be printed at the printer. Meanwhile, when the printer supports direct printing, the file itself may be the printing data.

The expression “user” as used herein may refer to a person who performs manipulation related with the image forming job using the image forming apparatus or a device connected to the image forming apparatus wiry or wirelessly. Further, the expression “manager” as used herein may refer to a person who has an authority to access all the functions and systems of the image forming apparatus. The “manager” and the “user” may refer to the same person.

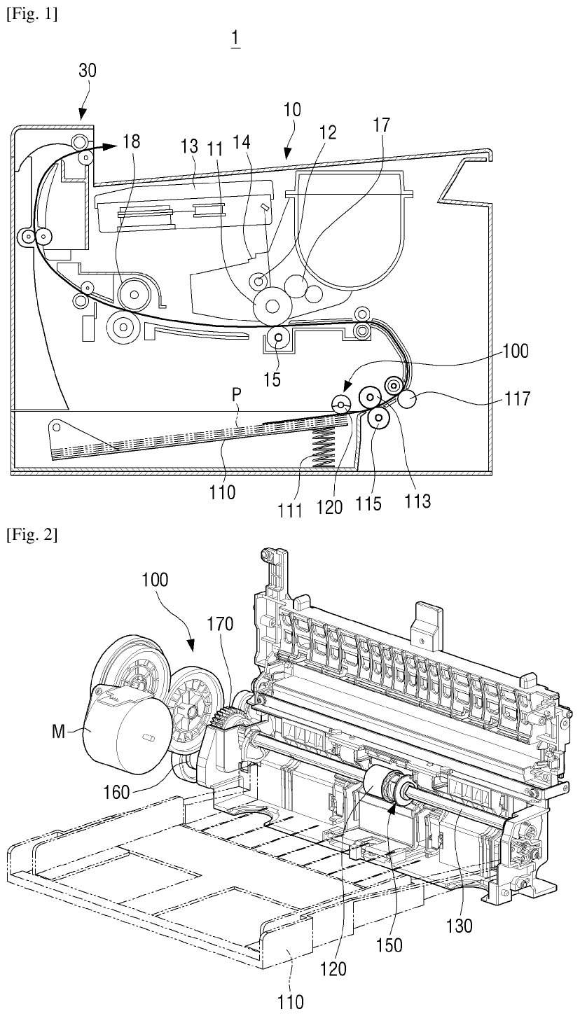

FIG. 1 is a schematic view illustrating an image forming apparatus according to an embodiment of the present disclosure.

Referring to FIG. 1, an image forming apparatus 1 may include a paper-feeding device 100, a print engine 10, and a discharging device 30.

The paper-feeding device 100 may accommodate paper P and supply the paper P to the print engine 10. The discharging device 30 may externally discharge the paper P which passes through the print engine 10. The description of the paper-feeding device 100 will be detailed below.

The print engine 10 may form an image on the paper P supplied from the paper-feeding device 100. The print engine 10 may form an image on the paper P using an electro-photo method.

The print engine 10 may include a photoconductive drum 11, a charger 12, an exposure device 13, a developing device 14, a transfer device 15, and a fixing device 18. Although the print engine 10 and the paper-feeding device 100 are shown as being different in configuration, the paper-feeding device 100 may be a configuration in the print engine 10.

An electrostatic latent image may be formed on the photoconductive drum 11.

Specifically, an electrostatic latent image may be formed on the photoconductive drum 11 by the operations of the charger 12 and the exposure device 13, which will be described below. The photoconductive drum 11 may be referred to as an image forming medium, a photoconductive drum, a photoconductive belt, etc. depending on its form.

The configuration of the print engine 10 corresponding to only one color will be exemplified for convenience of explanation. However, when the present disclosure is embodied, the print engine 10 may include a plurality of photoconductive drums 11, a plurality of chargers 12, a plurality of exposure devices 13, a plurality of developing devices 14 and an intermediate transfer belt (not shown) corresponding to a plurality of colors.

The charger 12 may charge the surface of the photoconductive drum 11 to a uniform potential. The charger 12 may be implemented in the form of a corona charger, a charging roller, a charging brush, or the like.

The exposure device 13 may form an electrostatic latent image on the surface of the photoconductive drum 11 by changing a surface potential of the photoconductive drum 11 according to image information to be printed. For example, the exposure device 13 may form an electrostatic latent image by irradiating light modulated according to the image information to be printed to the photosensitive drum 11. The exposure device 13 of this type may be referred to as a light scanning device or the like, and an LED may be used as a light source.

The developing device 14 may include a developer therein and supply a developer (e.g., toner) to the electrostatic latent image to develop the electrostatic latent image into a visible image. The developing device 14 may include a developing roller 17 which supplies the developer to the electrostatic latent image. For example, the developer may be supplied from the developing roller 17 to an electrostatic latent image formed in the photoconductive drum 11 by a developing electric field formed between the developing roller 17 and the photoconductive drum 11.

The visible image formed in the photosensitive drum 11 may be transferred to printing paper by the transfer device 15 or the intermediate transfer belt (not shown). The transfer device 15 may transfer a visible image to printing paper by using, for example, an electrostatic transfer method. The visible image may be attached to the printing paper by electrostatic attraction.

The fixing device 18 may fix a visible image on printing paper by applying heat or pressure to the visible image on the printing paper. A printing job may be completed by a series of processes.

The paper-feeding device 100 may accommodate the paper P, and include a tray 110, a pick-up roller 120, a forward roller 113, a retard roller 115, a conveying roller 117 to provide the paper P to the print engine 10.

The tray 110 may accommodate at least one piece of paper P, and the tray 110 may accommodate a predetermined number of pieces of paper P.

The tray 110 may load the paper P. The tray 110 may be elastically pressed in a direction of the pick-up roller 120 so as to bring the loaded paper P into contact with the pick-up roller 120. A pressing member 111 may be connected to the tray 110 to be pressed in the direction of the pick-up roller 120. One end of the pressing member 111 may be connected to the tray 110 to press the tray 110 in the direction of the pick-up roller 120.

The pressing member 111 may be, for example, a compression coil spring, but is not limited thereto. The pressing member 111 could be any type of pressing member which can press the tray 110 toward the pick-up roller 120.

The pick-up roller 120 may pick up the paper P in contact with the paper P. The pick-up roller 120 may be connected to a driving motor M (see FIG. 2), and pick up the paper P by rotating by a driving force transmitted from the driving motor M.

The pick-up roller 120 may be mounted above the tray 110, and may pick up the paper P one piece by one piece to convey a piece of paper toward the conveying roller 117. The pick-up roller 120 may convey a piece of paper P at the top of the loaded paper P toward the conveying roller 117.

The pick-up roller 120 may rotate to pick up the paper P loaded in the tray 110, and idly rotate when a front end of the paper P reaches the conveying roller 117. The pick-up roller 120 may rotate by indirectly receiving the driving force of the driving motor M when performing a paper-feeding operation, and idly rotate after picking up the paper P since the driving force is interrupted.

The forward roller 113 may be mounted at the front end of the tray 110, and may convey the paper P loaded in the tray 110 toward the conveying roller 117. Specifically, the forward roller 113 may convey the paper P picked up by the pick-up roller 120 in the tray 110 toward the conveying roller 117.

The forward roller 113 may convey the paper P picked up by the pick-up roller 120.

In order to convey the picked-up paper P, the forward roller 113 may be arranged to be adjacent to the pick-up roller 120.

The retard roller 115 may be arranged to be opposite to the forward roller 113 and may prevent conveyance of the printing paper P supplied from the tray 110.

The retard roller 115 may apply a frictional force to a rear surface of the paper P conveyed between the retard roller 115 and the forward roller 113 in a direction opposite to a paper feeding direction in order to prevent conveyance.

The retard roller 115 may be elastically pressed in the direction of the forward roller 113 so that the paper P conveyed between the forward 113 is in contact with the forward roller 113. An additional pressing member (not shown) may be connected to the retard roller 115 to press the retard roller 115 toward the forward roller 113.

The retard roller 115 may include a torque limiter (not shown) so that the retard roller 115 may rotate when the paper P conveyed between the forward roller 113 and the retard roller 115 is a piece of paper, but may not rotate when the paper P is two or more of pieces of paper.

The retard roller 115 may rotate forwardly or reversely. The retard roller 115 may allow only one piece of the paper P to be conveyed to the print engine 10 by separating paper when two or more of pieces of papers are conveyed when the forward roller 13 is pressed.

The conveying roller 117 may be formed of a pair of rollers facing each other and rotating, and may convey the paper P fed by the forward roller 113 toward the print engine 10.

When the pick-up roller 120 rotates, the paper P loaded at the top of the tray 110 may contact the pick-up roller 120 and access a convey path by a frictional force. The conveying rollers 117 for receiving the entered paper P and continuously conveying the paper P to the print engine 10 may rotate at the rear end of the pick-up roller 120.

It is enough if the pick-up roller 120 picks up the paper P so that the front end of the paper P reaches the conveying roller 117. Rather, if the pick-up roller 120 presses the rear end of the paper even when the paper P reaches the conveying roller 117, a load may occur in the paper conveyance.

The pick-up roller 120 may need to release the frictional force applied by the pick-up roller 120 to the paper P when the paper P reaches the conveying roller 117 for accurate feeding of the paper P. Accordingly, the pick-up roller 120 according to an embodiment of the present disclosure may drive in an idle state in order to release the frictional force applied by the pick-up roller 120 to the paper P when the paper P reaches the conveying roller 117 for accurate feeding of the paper P. The pick-up roller 120 may idly rotate and minimize the load applied to the paper P.

The pick-up roller 120 may periodically perform the rotation to apply a frictional force to the paper P to pick up the paper P and the idle rotation not to apply a frictional force to the paper P.

The detailed configuration of a power transmission member for selectively driving the pick-up roller 120 and the operation of the pick-up roller 120 will be described below.

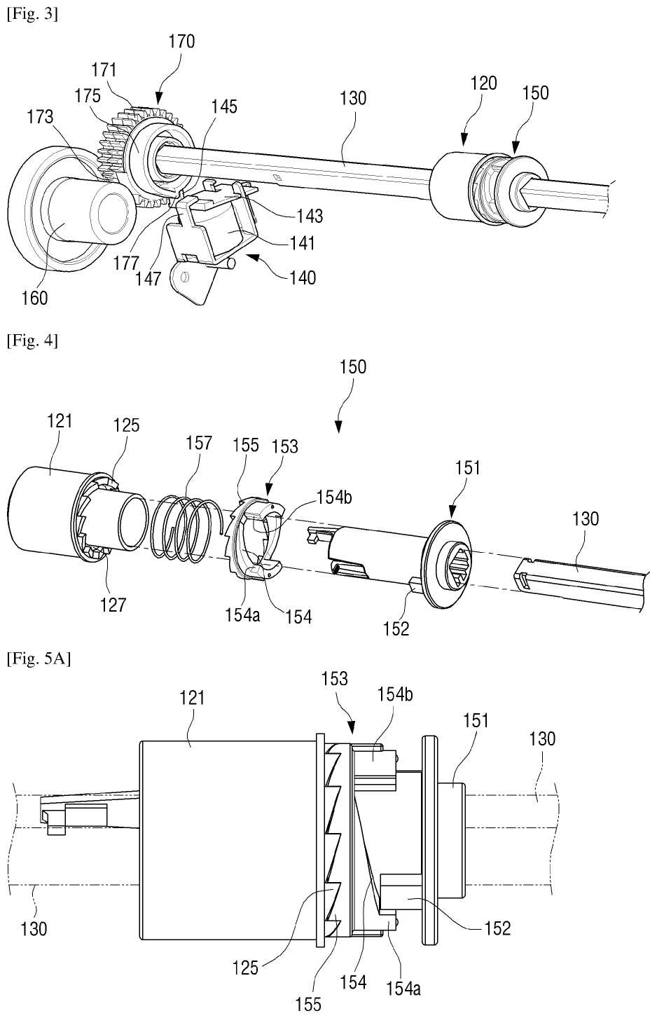

FIG. 2 is a perspective view illustrating a paper-feeding device according to an embodiment of the present disclosure, and FIG. 3 is a perspective view illustrating a portion of the paper-feeding device according to an embodiment of the present disclosure.

Referring to FIG. 2, a paper-feeding device 100 according to an embodiment of the present disclosure may include a tray 110, a pick-up roller 120, a conveying roller 117 (see FIG. 1), a solenoid 1400 for selectively rotating the driving shaft 130 which supports the pick-up roller 120, and a power transmission member 150 for transmitting a driving force of the driving shaft 130 to the pick-up roller 120.

The pick-up roller 120 may have a cylindrical shape where a cross-sectional is a circle as shown in FIG. 2. Since the pick-up roller 12 has a cylindrical shape, a pick-up speed of the pick-up roller 120 may increase. The pick-up roller 120 in a cylindrical shape may control a pick-up period of the paper P by using the solenoid 140.

The pick-up roller 120 may be rotatably mounted above the tray 110. The pick-up roller 120 may be mounted on the driving shaft 130 which rotates in a predetermined direction by a driving force from the driving motor M. The pick-up roller 120 may be rotated by the driving motor M and may separate a piece of paper at the top layer of the loaded paper P to convey the paper P toward the conveying roller 117.

The pick-up roller 120 may be coupled to the driving shaft 130 at the central area thereof to idly rotate. The pick-up roller 120 idly engaged with the driving shaft 130 may be rotationally driven together with the driving shaft 130 by the power transmission member 150.

The other end of the driving shaft 130 may be engaged with the solenoid 140 that controls the driving force from the driving motor M. When the driving force is transmitted by the solenoid 140, the driving shaft 130 may rotate in a direction where the paper P is picked up and conveyed.

The rotational force of the driving shaft 130 may be transmitted to the pick-up roller 120 through the power transmission member 150. The pick-up roller 120 may be selectively rotated while being coupled to or separated from the power transmission member 150 depending on whether the driving shaft 130 is rotated.

The paper-feeding device 100 may include the driving motor M which rotates the pick-up roller 120. The solenoid 140 may be disposed between the pick-up roller 120 and the driving motor M.

A pick-up gear 170 connected to the driving motor M may be mounted on one side of the driving shaft 130 which supports the pick-up roller 120. The pick-up gear 170 may be engaged with the driving gear 160 connected to the driving motor M, and the driving gear 160 may be connected to the driving motor M. The pick-up gear 170 may be gear-connected to the driving gear 160 of the driving motor M to receive a driving force.

When the driving gear 160 is rotated by the driving motor M, the pick-up gear 170 engaged with the driving gear 160 may rotate, and when the pick-up gear 170 is rotated, the driving shaft 130 connected to the pick-up gear 170 based on an axis may be rotated.

The pick-up gear 170 may include a tooth portion 171 and a cutting portion 173. The tooth portion 171 may be engaged with the driving gear 160. The cutting portion 173 may be engaged with the driving gear 160. The cutting portion 173 may serve to release the engagement between the driving gear 160 and the pick-up gear 170.

The trapping portion 177 may be provided on one side surface of the pick-up gear 170, and a guide unit 175 having a curvature may be formed as well.

The trapping portion 177 may be trapped by the solenoid 140 to control a rotation of the driving shaft 130.

The solenoid 140 for controlling the rotation of the driving shaft 130 may consist of a movable plate 143 and a supporting unit 147.

When power supply to the solenoid 140 is interrupted, the movable plate 143 may be supported by the supporting unit 147. A trapping protrusion 145 which externally protrudes to be trapped by the trapping portion 177 of the pick-up gear 170 may be formed at the front end of the movable plate 143.

The trapping protrusion 145 may be trapped by the trapping portion 177 while being guided along the guide unit 175 of the pick-up gear 170. When the trapping protrusion 145 of the movable plate 143 is trapped by the trapping portion 177 of the pick-up gear 170, the rotation of the pick-up gear 170 may be stopped, and the rotation of the driving shaft 130 by the pick-up gear 170 may be stopped.

When power is applied to the solenoid 140, the movable plate 143 may be in contact with an electromagnet 141, the trapping protrusion 145 of the movable plate 143 may be deviated from the trapping portion 177 of the pick-up gear 170, so that the driving shaft 130 may rotate.

To be specific, when the solenoid 140 is powered off, the trapping protrusion 145 protruding from the front end of the movable plate 143 may be trapped by the trapping portion 177 of the pick-up gear 170. The cutting portion 173 of the pick-up gear 170 may be adjacent to the driving gear 160, and interlocking between the pick-up gear 170 and the driving gear 160 may be released, so that the pick-up gear 170 and the driving shaft 130 may stop.

The driving shaft 130 connected to the pick-up roller 120 may be rotated at a position where one surface of the pick-up roller 120 is in contact with the paper P and stopped by the solenoid 140. When the driving shaft 130 stops, the pick-up roller 120 may be idly rotated by the conveyed paper P. Idle rotation of the pick-up roller 120 will be described below.

When power is temporarily applied to the solenoid 140, the movable plate 143 may be pulled by a suction force of the electromagnetic 141, so that the trapping protrusion 145 may be deviated from the trapping portion 177. Accordingly, the tooth portion 171 of the pick-up gear 170 may rotate while being interlocked with the driving gear 160, and the driving shaft 130 may rotate while being linked to the pick-up gear 170. When the driving shaft 130 is rotated, the pick-up roller 120 may receive a rotational driving force of the driving shaft 130 from the power transmission member 150, and rotate together with the driving shaft 130 while being linked thereto.

When the solenoid 140 is powered off, the movable plate 143 may move to the outer side of the electromagnetic 141, and the trapping protrusion 145 may be guided along with the guide unit 175. When the trapping protrusion 145 of the movable plate 143 is trapped by the trapping portion 177 while being guided along the guide unit 175, the cutting portion 173 of the pick-up gear 170 may be adjacent to the driving gear 160, and the interlocking between the pick-up gear 170 and the driving gear 160 may be released by the cutting portion 173. Thus, the pick-up gear 170 and the driving shaft 130 may be stopped.

Since the pick-up roller 120 is separated from the power transmission member 150, the pick-up roller 120 may idly rotate by the conveyed paper P. Since the pick-up roller 120 idly rotates, a frictional force applied to the paper P may be minimized. As a result, the paper P may be accurately conveyed.

When power is applied to the solenoid 140, since the rotation of the pick-up gear 170 is not controlled, the pick-up gear 170 and the driving shaft 130 which is rotated by the pick-up gear 170 may rotate.

In other words, the solenoid 140 may selectively rotate the driving shaft 130. When power is supplied to the solenoid 140, the driving shaft 130 may rotate, and when the solenoid 140 is powered off, the driving shaft 130 may stop rotating.

When the driving shaft 130 is rotated, the power transmission member 150 may be rotatably moved within a predetermined angle range, and engaged with the pick-up roller 120 to couple the pick-up roller 120 to the driving shaft 130. The coupled pick-up roller 120 may rotate together with the driving shaft 130 by the power transmission member 150 and separately convey a plurality of pieces of paper loaded in the tray 110 one by one.

When the trapping portion 177 of the pick-up gear 170 rotates once during the rotation of the pick-up gear 170, that is, when the trapping portion 177 returns to an its original position, the solenoid 140 may be powered off, the movable plate 143 of the solenoid 140 may move toward the supporting unit 147, and the trapping protrusion 145 may be trapped by the trapping portion 177, thereby controlling the rotation of the pick-up gear 170. In other words, the solenoid 140 may selectively control the rotation of the driving shaft 130.

Since the pick-up roller 120 is coupled to the driving shaft 130 to be idly rotatable, the pick-up roller 120 cannot rotate only by the rotation of the driving shaft 130, but may rotate by receiving the driving force of the driving shaft 130 through the power transmission member 150.

The power transmission member 150 may be coupled to or spaced apart from the pick-up roller 120 and may selectively provide the driving force of the driving shaft 130 to the pick-up roller 120. The detailed configuration of the power transmission member 150 will be made below.

FIG. 4 is an exploded view illustrating the portion shown in FIG. 3.

Referring to FIG. 4, a pick-up roller 120 may include a pick-up housing 121 which accommodates the pick-up roller 120. The pick-up housing 121 may be selectively coupled to the power transmission member 150 which transmit a rotational force of the driving shaft 130 to the pick-up roller 120.

The pick-up housing 121 may be in contact with the paper P, and may rotate while being linked to the driving shaft 130 through the power transmission member 150 to pick up and convey the paper P. The pick-up housing 121 may include a material with a relatively high coefficient of friction such as synthetic rubber. A portion of the pick-up housing 121 may pick up the paper P by the frictional force by the contact of the paper P.

A second tooth portion 125 which is coupled to a first tooth portion 155 of the connection member 153 may be formed at one end of the pick-up housing 121 coupled to the power transmission member 150.

In addition, a groove 127 where an elastic member 157 for separating the pick-up roller 120 from the connection member 153 is disposed may be formed at one end of the pick-up housing 121. The groove 127 may be formed in a concave shape to support one side of the elastic member 157 described below.

The pick-up housing 121 may be coupled to the power transmission member 150 when the driving shaft 130 is rotated, and the pick-up housing 121 may be separated from the power transmission member 150 when the driving shaft 130 stops.

The power transmission member 150 may be coupled to the pick-up roller 120 while the driving shaft 130 is rotated, so that the pick-up roller 120 may be rotated by the driving force. The power transmission member 150 may be separated from the pick-up roller 120 when the driving shaft 130 stops, so that the pick-up roller 120 may be idly rotated.

The power transmission member 150 which is coupled to or spaced apart from the pick-up housing 121 may selectively transmit the rotational force of the driving shaft 130 to the pick-up roller 120. The power transmission member 150 may include a holder 151, a connection member 153, and an elastic member 157.

The holder 151 may be fixedly coupled to the driving shaft 130, rotated together with the driving shaft 130, and disposed on one side of the pick-up roller 120. A stopper 152 which protrudes toward the connection member 153 may be formed at the holder 151. The stopper 152 may rotate together with the driving shaft 130 and move the connection member 153.

It is described that the stopper 152 which moves the connection member 153 is provided at the holder 151, but the present disclosure is not limited thereto. The holder 151 or the stopper 152 may be integrally formed with the driving shaft 130.

The connection member 153 may be coupled to the driving shaft 130 so as to be idly driven. There may a slight gap between the driving shaft 130 and the connection member 153, so that the connection member 153 could be idly rotated when it is not necessary to transmit power to the pick-up roller 120.

The connection member 153 may be disposed between the holder 151 and the pick-up roller 120. The connection member 153 may be selectively coupled to or separated from the pick-up roller 120 while moving between the holder 151 and the pick-up roller 120 along an axis direction of the driving shaft 130.

The connection member 153 may include an inclined portion 154 guided by the stopper 152 in a direction toward the stopper 152. Both ends of the inclined portion 154 may be a first trapping end 154A and a second trapping end 154B that control a radius of rotation of the stopper 152. The inclined portion 154 may obliquely extend from the first trapping end 154A toward the second trapping end 154B.

The stopper 152 may be disposed between the first trapping end 154A and the second trapping end 154B and may contact the first trapping end 154A or the second trapping end 154B by the rotation of the driving shaft 130.

The first tooth portion 155 which can be selectively coupled to the pick-up housing 121 may be provided at the other end of the connection member 153. The first tooth portion 155 may be formed so as to be engaged with the second tooth portion 125 formed in the pick-up housing 121.

The connection member 153 may be formed in a ring shape having a predetermined width surrounding the outer periphery of the holder 151. The first tooth portion 155 may be formed in a saw tooth shape along the other side toward the pick-up housing 121 so as to be coupled to the pick-up housing 121.

The inclined portion 154 may be partly formed in a spiral shape along the axis line of the drive shaft 130 in a direction toward the holder 151, which is opposite to a direction where the first tooth portion 155 is provided. The stopper 152 of the holder 151 may control a radius of rotation by being trapped by the first trapping end 154A or the second trapping end 154B of the inclined portion 154.

The second tooth portion 125 provided at one end of the pick-up housing 121 may be formed in a saw tooth shape corresponding to the first tooth portion 155 of the connection member 153, so that the pick-up housing 121 and the connection member 153 may be coupled to each other.

In addition, a concaved groove (not shown) may be provided at the other end of the connection member 153 in order to support the other side of the elastic member 157. The one end of the elastic member 157 may be supported by the groove 127 of the pick-up housing 121, and the other end of the elastic member 157 may be supported by a groove of the connection member 153.

When the driving shaft 130 rotates, the pick-up roller 120 may rotate by coupling between the holder 151 and the connection member 153 and coupling between the connection member 153 and the pick-up housing 121. The rotational force of the driving shaft 130 may be transmitted to the pick-up roller 120 through the holder 151 and the connection member 153, and the pick-up roller 120 may be rotated in the same direction as the driving shaft 130.

The one side of the connection member 153 may be coupled to the holder 151 by the rotation of the driving shaft 130 and the holder 151, and the other end of the connection member 153 may be coupled to the pick-up housing 121. Accordingly, a rotational force of the driving shaft 130 may be transmitted to the pick-up roller 120. The pick-up roller 120 may be rotated to pick up and convey the paper P.

When power is supplied to the solenoid 140, the driving shaft 130 may be rotated, and the connection member 153 may be moved in the direction of the pick-up roller 120 by the holder 151 which integrally rotates with the driving shaft 130 to be engaged with the pick-up housing 121. The pick-up roller 120 engaged with the connection member 153 may be integrally rotated with the driving shaft 130. The connection member 153 may be engaged with the pick-up housing 121 to transmit a rotational driving force of the driving shaft 130 to the pick-up roller 120.

When the solenoid 140 is powered off, the driving shaft 130 may stop and the pick-up roller 120 may be separated from the power transmission member 150 by the elastic member 157 disposed between the pick-up housing 121 and the connection member 153. The elastic member 157 may elastically press the connection member 153 in the direction of the holder 151, so that the connection member 153 may be spaced apart from the pick-up roller 120.

When the driving shaft 130 stops, the paper P may be conveyed in contact with the pick-up roller 120. Thus, the pick-up roller 120 separated from the power transmission member 150 may be idly rotated, thereby minimizing a frictional force.

When the driving shaft 130 is rotated, the holder 151 may be rotated together with the driving shaft 130. The connection member 153 and the pick-up housing 121 may be coupled to each other when the holder 151 is within a predetermined rotational range.

Specifically, while the stopper 152 of the holder 151 is trapped by the first trapping end 154A of the connection member 153, the stopper 152 may guide the connection member 153 to move toward the pick-up housing 121 while rotating along the inclined portion 154.

The stopper 152 may guide the connection member 153 to rotatably move in the direction of the pick-up housing 121 by the inclined portion 154, which is upwardly inclined, while rotating from the second trapping end 154B to the first trapping end 154A.

The stopper 152 may rotatably move so as to be trapped by the first trapping end 154A so that the connection member 153 may be coupled to the pick-up housing 121. The first tooth portion 155 of the connection member 153 which is rotatably moved may be engaged with the second tooth portion 125 of the pick-up housing 121. The stopper 152 may press the first trapping end 154A in the rotational direction of the driving shaft 130, and transmit the rotational force of the driving shaft 130 to the pick-up housing connected to the connection member 153. The connection member 153 may be rotated together with the pick-up roller 120 in the rotational direction of the driving shaft 130 by the rotational force of the driving shaft 130.

The elastic member 147 may wind the pick-up housing 121, the one end of the elastic member 147 may be supported by the pick-up housing 121, and the other end of the elastic member 147 may be supported by the connection member 153. The elastic member 157 may elastically press the connection member 153 in a direction away from the pick-up housing 121.

When the driving shaft 130 is rotated, the diameter of the elastic member 157 wound by the connection member 153 which rotatably moves in the direction of the pick-up housing 121 may be reduced. Accordingly, the elastic member 157 may elastically press the connection member 153 in the direction of the holder 151. When the driving shaft 130 stops, the winding diameter of the elastic member 157 which has been reduced upon rotation of the drive shaft 130 can be restored to the original state. The connection member 153 may be separated from the pick-up housing 121 by the elasticity of the elastic member 157.

When the driving shaft 130 is stopped by the elastic member 157, the connecting member 153 may be rotated and moved to a position away from the pick-up roller 120.

It is described that the elastic member 157 is wound by the pick-up housing 121, but the present disclosure is not limited thereto. The elastic member 157 may be wound by the driving shaft 130, and it is enough if the elastic member 157 is disposed between the pick-up roller 120 and the connection member 153.

The power transmission member 150 may rotate the pick-up roller 120 to pick up and convey the paper P while the driving shaft 130 is rotated. When the front end of the paper P reaches the conveying roller 117 after the paper P is picked up, the driving shaft 130 may be stopped by the solenoid 140, and when the driving shaft 130 stops, the pick-up roller 120 may idly rotate. The paper-feeding device 100 according to an embodiment of the present disclosure may reduce the friction between the pick-up roller 120 and the paper P and easily convey the paper P.

The cost can be reduced compared to a conventional paper-feeding device using an electromagnetic clutch by using the solenoid 140. When the driving shaft 130 is driven, the power transmission member 150 may transmit the driving force of the driving shaft 130 to the pick-up roller 120 while being combined with the pick-up roller 120, and when the driving shaft 130 stops, the power transmission member 150 may allow the idle rotation of the pick-up roller 120 while being separated from the pick-up roller 120 by a pressing force of the elastic member 157.

The detailed operation of the power transmission member 150 which can be selectively coupled to the pick-up roller 120 depending on whether the driving shaft 130 is rotated will be described in detail below.

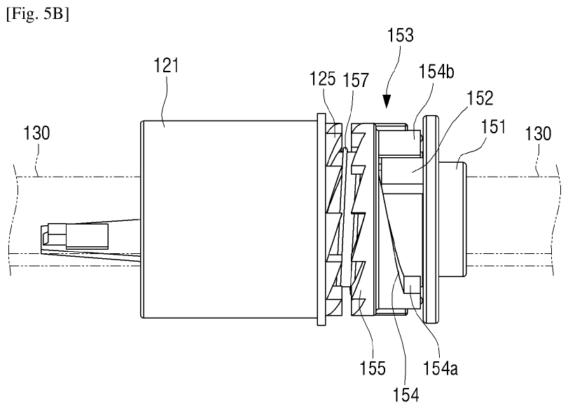

FIGS. 5A and 5B are schematic views showing an operation state of a pick-up roller according to an embodiment of the present disclosure.

Referring to FIG. 5A, when power is temporarily applied to the solenoid 140, the pick-up gear 170 may rotate in engagement with the driving gear 160 and the driving shaft 130 may rotate while being linked to the pick-up gear 170.

The power transmission member 150 may be rotatably moved within a predetermined angle range by the rotational force of the driving shaft 130 which is rotated by the solenoid 140 and combined with the pick-up roller 120. After being combined with the pick-up roller 120, the power transmission member 150 may synchronize the combined pick-up roller 120 with the driving shaft 130. The pick-up roller 120 synchronized with the driving shaft 130 may rotate together with the driving shaft 130 and pick up the paper P.

When the driving shaft 130 is rotated, the holder 151 may rotate together with the driving shaft 130. The stopper 152 may rotate toward the first trapping end 154A by the rotation of the holder 151. The stopper 152 may be trapped by the first trapping end 154A along the inclined portion 154 and press the first trapping end 154A. The connection member 153 may move in the direction of the pick-up housing 121 by the rotation of the stopper 152 to be combined with the pick-up housing 121.

Since the stopper 152 continuously presses the first trapping end 154A while the driving shaft 130 is rotated, the coupling between the connection member 153 and the pick-up housing 121 may be maintained. Accordingly, the pick-up roller 120 may receive the driving force of the driving shaft 130 through the connection member 153 and rotate together with the driving shaft 130 while being linked thereto.

Referring to FIG. 5B, when the solenoid 140 is powered off, the pick-up gear 170 and the driving shaft 130 may stop.

When the driving shaft 130 stops, since the pressing force of the stopper 152, which is applied to the first trapping end 154A, is released, the connection member 153 may be spaced apart from the pick-up housing 121 by the elasticity of the elastic member 157.

The elastic member 157 may be disposed between the pick-up housing 121 and the connection member 153 and may apply pressure to the connection member 153 that moves to the pick-up housing 121 in the direction of the holder 151. Since the driving shaft 130 stops, the pressing force of the holder 151 applied to the connection member 153 may be smaller than the elastic force of the elastic member 157, so that the connection member 153 may be rotatably moved in a direction opposite to the pick-up roller 120 by the elastic member 157.

Since the paper P is conveyed in contact with the pick-up roller 120 in a state in which the driving shaft 130 stops, the pick-up roller 120 may be rotated by a frictional force with the paper P. The pick-up roller 120 that is rotated by the paper P may rotate in the same direction as the rotational direction of the driving shaft 130.

The second tooth portion 125 may be rotated by the rotation of the pick-up roller 120, and the first tooth portion 155 combined with the second tooth portion 125 may be rotated. Since the driving shaft 130 stops, the holder 151 may not rotate and the stopper 152 may contact the second trapping end 154B by the rotation of the connection member 153.

When the stopper 152 presses the second trapping end 154B and the pick-up roller 120 is rotated, the first tooth portion 155 may be deviated from the second tooth portion 125, so that the connection member 153 may be spaced apart from the pick-up housing 121. When the connection member 153 is separated from the pick-up roller 120, the pick-up roller 120 may idly rotate by the contact with the paper P.

In addition, a paper jam could occur between a pick-up roller and a retard roller while an image forming apparatus performs a printing operation. In this case, when paper is to be removed, the pick-up roller 120 may reversely rotate by the frictional force with the paper P. The power transmission member 150 and the pick-up roller 120 may be separated from each other, so that the pick-up roller 120 can idly rotate by the contact with the paper P.

When paper is conveyed to a conveying roller after passing through a pick-up roller, the frictional force provided to the paper needs to be released for accurate conveyance. The pick-up roller 120 may selectively perform the rotation for picking up the paper P and the idle rotation. When the front end of the paper P reaches the conveying roller 117, the pick-up roller 120 may idly drive to reduce the load at the rear end of the paper, so that the paper can be accurately conveyed.

Meanwhile, a paper jam may occur between a pick-up roller and a retard roller when an image forming apparatus performs a printing operation. The pressing force applied to the paper needs to be released to remove the paper trapped between the pick-up roller and the retard roller. Even when the paper jam occurs and the pick-up roller reversely rotates for removing the paper, the pick-up roller 120 may idly rotate, so that the load applied to the paper P may be reduced.

Although embodiments have been shown and described, it will be appreciated by those skilled in the art that changes may be made to these embodiments without departing from the principles and spirit of the present disclosure. Accordingly, the scope of the present disclosure is not construed as being limited to the described embodiments, but is defined by the appended claims as well as equivalents thereto.

1. An image forming apparatus, comprising:
a paper-feeding device configured to accommodate paper;
a print engine configured to form an image on paper supplied from the paper-feeding device; and
a discharging device configured to discharge paper on which an image is formed by the print engine,
wherein the paper-feeding device comprises:
a pick-up roller in a cylindrical shape configured to pick up paper loaded in a tray;
a driving shaft configured to support the pick-up roller to idly rotate, and rotate in a predetermined direction;
a solenoid configured to selectively rotate the driving shaft; and
a power transmission member configured to selectively provide a driving force of the driving shaft to the pick-up roller, the power transmission member being coupled to or spaced apart from the pick-roller,
wherein the power transmission member is engaged with the pick-up roller within a predetermined rotational range of the driving shaft.

2. The image forming apparatus as claimed in claim 1, wherein the pick-up roller is, based on the driving shaft being rotated, engaged with the driving shaft by the power transmission member which rotatably moves within a predetermined angle range, and the engaged pick-up roller rotates together with the driving shaft, and
wherein the pick-up roller is, based on the driving shaft being stopped, spaced apart from the power transmission member and separated from the driving shaft to idly rotate.

3. The image forming apparatus as claimed in claim 1, wherein the power transmission member comprises:
a holder configured to rotate together with the driving shaft, the holder being disposed on one side of the pick-up roller;
a connection member disposed to be movable between the holder and the pick-up roller; and
an elastic member disposed between the pick-up roller and the connection member.

4. The image forming apparatus as claimed in claim 3, wherein the pick-up roller is, based on the driving shaft being rotated, engaged with the power transmission member, and
wherein the pick-up roller is, based on the driving shaft being stopped, separated from the power transmission member by the elastic member.

5. The image forming apparatus as claimed in claim 3, wherein the connection member is engaged with the driving shaft to be idly rotated.

6. The image forming apparatus as claimed in claim 3, wherein a second tooth portion extending in a length direction is formed at one end of the connection member, and
wherein a first tooth portion engaged with a tooth portion of the connection member is formed at the pick-up roller.

7. The image forming apparatus as claimed in claim 6, wherein, based on the driving shaft being rotated, a first tooth portion of the connection member is engaged with a second tooth portion of the pick-up roller and a rotational force of the driving shaft is transmitted to the pick-up roller.

8. The image forming apparatus as claimed in claim 6, wherein, based on the driving shaft being stopped, a first tooth portion of the connection member is deviated from a second tooth portion of the pick-up roller and the driving force of the driving shaft is interrupted.

9. The image forming apparatus as claimed in claim 3, wherein the holder comprises a stopper protruding toward the connection member, and wherein the connection member includes an inclined portion guided by the stopper.

10. The image forming apparatus as claimed in claim 9, wherein the stopper moves the connection member to contact one of both ends of the inclined portion by rotation of the driving shaft.

11. The image forming apparatus as claimed in claim 9, wherein the stopper is trapped at both ends of the inclined portion to control a radius of rotation of the connection member.

12. The image forming apparatus as claimed in claim 3, wherein the elastic member is formed of a torsion spring wound by the driving shaft.

13. The image forming apparatus as claimed in claim 12, wherein, based on the solenoid being powered on, the connection member is engaged with the pick-up roller by rotation of the driving shaft, and the pick-up roller engaged with the power transmission member is rotated together with the driving shaft, and
wherein, based on the solenoid being power off, the connection member is separated from the pick-up roller by a restoring force of the elastic member, and the pick-up roller separated from the power transmission member is idly rotated.

14. A paper-feeding device, comprising:
a pick-up roller in a cylindrical shape configured to pick up paper loaded in a tray;
a driving shaft configured to selectively rotate the pick-roller; and
a power transmission member configured to selectively provide a driving force of the driving shaft to the pick-up roller,
wherein the power transmission member is rotatably moved within a predetermined angle range by a rotational force of the driving shaft to be engaged with the pick-up roller and rotated together with the engaged pick-up roller.

15. The paper-feeding device as claimed in claim 14, wherein the pick-up roller is, based on the driving shaft being rotated, engaged with the power transmission member and rotated together with the driving shaft, and
wherein the pick-up roller is, based on the driving shaft being stopped, separated from the power transmission member to idly rotate.
